(19) United States
(12) Patent Application Publication
(10) Pub. No.: US 2023/0415306 A1
(43) Pub. Date: Dec. 28, 2023

(54) APPARATUS AND METHOD FOR PRODUCING CO2 PELLETS FROM CO2 SNOW, AND CLEANING APPLIANCE

(71) Applicant: Alfred Kärcher SE & Co. KG, Winnenden (DE)

(72) Inventors: Rick Petzold, Winnenden (DE); Lars Eckstein, Winnenden (DE)

(21) Appl. No.: 18/315,410

(22) Filed: May 10, 2023

Related U.S. Application Data
(63) Continuation of application No. PCT/EP2021/081331, filed on Nov. 11, 2021.

(30) Foreign Application Priority Data
Nov. 11, 2020 (DE) 10 2020 129 723.8

(51) Int. Cl. B24C 11/00; B24C 7/00; B24C 1/00

(52) U.S. Cl. CPC B24C 11/00; B24C 1/003; B24C 7/0069

(57) ABSTRACT

The invention relates to an apparatus for producing, in particular high-strength, CO₂ pellets from CO₂ snow, in particular for a cleaning appliance for blasting surfaces to be treated with a mixed stream of a pressurized gas and CO₂ pellets, wherein the apparatus comprises a compressing device for compressing CO₂ snow to form CO₂ pellets and a delivery device for delivering the CO₂ pellets into a pressurized gas stream, wherein the apparatus comprises a fluid mechanical transfer device for conveying CO₂ pellets from the compressing device to the delivery device and wherein the transfer device is arranged or formed between the compressing device and the delivery device.

Furthermore, an improved cleaning appliance and an improved method for producing CO₂ pellets from CO₂ snow are proposed.

### CROSS-REFERENCE TO RELATED APPLICATIONS

This application is a continuation of international application number PCT/EP2021/081331, filed on Nov. 11, 2021, and claims the benefit of German application number 10 2020 129 723.8, filed on Nov. 11, 2020, which are incorporated herein by reference in their entirety and for all purposes.

### FIELD OF THE INVENTION

The present invention relates to apparatuses for producing CO₂ pellets from CO₂ snow in general, and more specifically to an apparatus for producing, in particular high-strength, CO₂ pellets from CO₂ snow, in particular for a cleaning appliance for blasting surfaces to be treated with a mixed stream of a pressurized gas and CO₂ pellets, wherein the apparatus comprises a compressing device for compressing CO₂ snow to form CO₂ pellets and a delivery device for delivering the CO₂ pellets into a pressurized gas steam.

Furthermore, the present invention relates to cleaning appliances in general, and more specifically to a cleaning appliance for blasting surfaces to be treated with a mixed stream of a pressurized gas and CO₂ pellets.

The present invention further relates to methods for producing CO₂ pellets from CO₂ snow in general, and more specifically to a method for producing, in particular high-strength, CO₂ pellets from CO₂ snow, in particular for a cleaning appliance for blasting surfaces to be treated with a mixed stream of a pressurized gas and CO₂ pellets, in which method CO₂ snow is compressed to form CO₂ pellets.

### BACKGROUND OF THE INVENTION

Apparatuses and cleaning appliances of the kind described at the outset are known, e.g., from DE 10 2013 113 275 A1. With an apparatus of the kind described at the outset, in particular, high-strength CO₂ pellets can be made from CO₂ snow.

A problem with apparatuses of that kind is, in particular, that CO₂ pellets in the apparatus before the delivery device adhere particularly to inner wall surfaces. This can lead, in particular, to undesired clogging of the apparatus, causing the production of CO₂ pellets to have to be interrupted.

### SUMMARY OF THE INVENTION

In a first aspect of the invention, an apparatus for producing, in particular high-strength, CO₂ pellets from CO₂ snow is provided, in particular for a cleaning appliance for blasting surfaces to be treated with a mixed stream of a pressurized gas and CO₂ pellets. The apparatus comprises a compressing device for compressing CO₂ snow to form CO₂ pellets and a delivery device for delivering the CO₂ pellets into a pressurized gas stream. The apparatus comprises a fluid mechanical transfer device for conveying CO₂ pellets from the compressing device to the delivery device. The transfer device is arranged or formed between the compressing device and the delivery device.

In a second aspect of the invention, a cleaning appliance for blasting surfaces to be treated with a mixed stream of a pressurized gas and CO₂ pellets is provided. The cleaning appliance comprises an apparatus for producing, in particular high-strength, CO₂ pellets from CO₂ snow. The apparatus comprises a compressing device for compressing CO₂ snow to form CO₂ pellets and a delivery device for delivering the CO₂ pellets into a pressurized gas stream. The apparatus comprises a fluid mechanical transfer device for conveying CO₂ pellets from the compressing device to the delivery device. The transfer device is arranged or formed between the compressing device and the delivery device.

In a third aspect of the invention, a method for producing, in particular high-strength, CO₂ pellets from CO₂ snow is proposed, in particular for a cleaning appliance for blasting surfaces to be treated with a mixed stream of a pressurized gas and CO₂ pellets, in which method CO₂ snow is compressed to form CO₂ pellets. The formed CO₂ pellets are fluid mechanically transferred for delivery or introduction into a pressurized gas stream.

### BRIEF DESCRIPTION OF THE DRAWING FIGURES

The foregoing summary and the following description may be better understood in conjunction with the drawing figures, of which:

FIG. 1: shows a schematic depiction of a cleaning appliance for blasting surfaces to be cleaned with a mixed stream of a pressurized gas and CO₂ pellets;

FIG. 2: shows a schematic perspective partial view of an apparatus for producing CO₂ pellets;

FIG. 3: shows an exploded depiction of part of the arrangement from FIG. 2;

FIG. 4: shows an enlarged partially cut partial view of the arrangement from FIG. 2;

FIG. 5: shows a further partially cut partial view of the arrangement from FIG. 2;

FIG. 6: shows a further partially cut partial view of the arrangement from FIG. 2;

FIG. 7: shows a further partially cut partial view of the arrangement from FIG. 2;

FIG. 8: shows a section view along line 8-8 in FIG. 5;

FIG. 9: shows a further partially cut view of the arrangement from FIG. 2;

FIG. 10: shows a schematic depiction of a further embodiment of an apparatus for producing CO₂ pellets from CO₂ snow;

FIG. 11: shows a schematic depiction of a further embodiment of an apparatus for producing CO₂ pellets from CO₂ snow;

FIG. 12: shows a schematic depiction of a further embodiment of an apparatus for producing CO₂ pellets from CO₂ snow;

FIG. 13: shows a schematic perspective partially broken exploded depiction of a further embodiment of a main compressor; and

FIG. 14: shows a section view of the arrangement from FIG. 13 analogous to FIG. 8.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The invention relates to an apparatus for producing, in particular high-strength, CO₂ pellets from CO₂ snow, in particular for a cleaning appliance for blasting surfaces to be treated with a mixed stream of a pressurized gas and CO₂ pellets, wherein the apparatus comprises a compressing device for compressing CO₂ snow to form CO₂ pellets and a delivery device for delivering the CO₂ pellets into a pressurized gas stream, wherein the apparatus comprises a fluid mechanical transfer device for conveying CO₂ pellets from the compressing device to the delivery device and wherein the transfer device is arranged or formed between the compressing device and the delivery device.

The proposed further development of an apparatus of the kind described at the outset makes it possible, in particular in a simple manner, to transfer the CO₂ pellets formed with the compressing device to the delivery device in a defined manner. The fluid mechanical configuration of the transfer device makes it possible, in particular, to convey the CO₂ pellets supported with a transfer gas. The transfer gas can be used, in particular, to achieve a continuous movement of the CO₂ pellets in the transfer device. Further, it is thus also possible to minimize a risk of adhesion of CO₂ pellets, for example to side or delimiting walls of the transfer device. By means of a transfer gas stream, in particular, a force can be exerted on the CO₂ pellets, which hinders the latter from adhering to walls of the transfer device. In addition, the flowing transfer gas can detach CO₂ pellets that are already adhering. These properties of the transfer device can be achieved, in particular, by guiding a transfer gas stream through the transfer device in a targeted manner. The transfer device is correspondingly constructed and optimized to this end.

It is favorable if the transfer device has a transfer device inlet, if the compressing device has a compressing device outlet, and if the compressing device outlet and the transfer device inlet are fluidically connected to one another. This configuration makes it possible, in particular, to introduce CO₂ pellets formed with the compressing device directly into the transfer device. Thus, in particular, a compact apparatus for producing CO₂ pellets can be formed.

It is advantageous if the transfer device comprises a collection hopper and if the collection hopper tapers in cross section in the direction toward the delivery device. In particular, the transfer device may also be formed by a collection hopper. The collection hopper makes it possible, in particular, to conduct or guide CO₂ pellets, due to the weight force acting on them, to an outlet of the hopper in order to conduct or guide the CO₂ pellets to an inlet of the delivery device. The collection hopper forms, in particular, part of the fluid mechanical transfer device. Gas flowing into and through said part can, in particular, be accelerated in the direction toward the delivery device due to the tapering cross section. CO₂ pellets can thus be conveyed in a targeted manner and adhering CO₂ pellets can be detached from an inner wall of the transfer device, in particular from a delimiting wall of the collection hopper.

During intended use of the apparatus, the collection hopper is preferably oriented in parallel or substantially in parallel to the direction of gravity and tapers in the direction of gravity. This configuration makes it possible, in particular, to optimally utilize the gravitational force acting on the CO₂ pellets in order to transfer the CO₂ pellets from the compressing device to the delivery device.

It is favorable if an introduction opening of the collection hopper is arranged or formed below the compressing device outlet relative to the direction of gravity. It is thus possible, in particular, for CO₂ pellets formed with the compressing device to be able to fall directly into the transfer device due to the gravitational force acting on them.

In order to be able to transfer CO₂ pellets in a defined manner from the compressing device to the delivery device and, in particular, also to intermediately store them, for example when the compressing device is operated in an intermittent operating mode, it is favorable if the transfer device comprises a transfer space and if the transfer space is arranged or formed between the compressing device outlet and the introduction opening.

In order to, in particular, be able to already somewhat accelerate excess CO₂ gas, which arises as exhaust gas when forming the CO₂ pellets with the compressing device, before flowing through the collection hopper, it is advantageous if the transfer space tapers in the direction of gravity at least in sections or comprises an upper part of the collection hopper relative to the direction of gravity.

It is favorable if the transfer space is subdivided by a dividing element into at least one first transfer space region and at least one second transfer space region. Due to the dividing element, it is possible, in particular, to achieve a defined flow of the transfer gas or the excess CO₂ gas through the transfer space. In particular, the dividing element can subdivide the transfer space into differently sized transfer space regions. The first transfer space region, which is fluidically connected to the compressing device outlet, is preferably smaller than the second transfer space region. It is thus possible, in particular, to accelerate the gas upon flowing through the first transfer space region in order to enable an optimal transport of the CO₂ pellets through the transfer device to the delivery device. In particular, the first transfer space region may taper in cross section at least in sections in order to accelerate a flow speed of the transfer gas through the first transfer space region in the direction toward the delivery device. Thus, in particular, CO₂ pellets adhering to delimiting walls of the transfer space and to the collection hopper can be detached in a simple manner in order to prevent clogging of the transfer device with CO₂ pellets. If the first transfer space region is smaller than the second transfer space region, the gas can, in particular, be decelerated upon entry into the second transfer space region. For example, it can thus be prevented that CO₂ pellets are able to travel into the second transfer space region.

The dividing element favorably defines a first dividing element side face, which points in the direction toward the compressing device outlet and laterally delimits the first transfer space region. In this configuration, the dividing element, in particular, takes on the function of a baffle plate, against which CO₂ pellets exiting the compressing device strike and can be slowed, so that they can be moved, in particular accelerated, in the direction toward the collection hopper and in the direction toward the delivery device due to the gravitational force acting on them and due to the flowing transfer gas.

The apparatus can be configured in a simple manner if the first dividing element side face extends in parallel or substantially in parallel to the direction of gravity. In particular when the compressing device has a compressing device outlet that is open transversely to the direction of gravity, a flow of the CO₂ pellets can thus be redirected in a simple manner in a direction parallel to the direction of gravity.

The dividing element preferably reaches at least up to the collection hopper. Thus, in particular, CO₂ pellets can be guided in a defined manner from the compressing device outlet to the collection hopper.

It is advantageous if the dividing element dips at least with its lower part relative to the direction of gravity into the collection hopper. This configuration has the advantage, in particular, that a constriction can thus be formed between the dividing element, in particular a side face thereof pointing toward the compressing device outlet, and an opposing delimiting wall of the collection hopper. This fluid mechanical design of the transfer device enables in a simple manner an acceleration of the gas flowing therethrough and thus a simpler and easier conveyance of the CO₂ pellets from the compressing device outlet to the delivery device.

It is favorable if the collection hopper defines a hopper height that extends from the introduction opening, which defines the greatest cross section of the collection hopper, up to a collection hopper outlet, which defines the smallest cross section of the collection hopper, and if a relative immersion depth of the dividing element into the collection hopper commencing from the introduction opening is in a range of about 10% to about 50% relative to the hopper height. In particular, the ratio of the immersion depth and the hopper height may be in a range of about 20% to about 40%. Such a configuration makes it possible, in particular, to form a defined constriction for accelerating excess CO₂ gas in the region of the collection hopper. In this way, in particular, CO₂ pellets adhering to the collection hopper can be detached in a simple manner.

In order to facilitate the transfer of the CO₂ pellets in the direction toward the delivery device, it is advantageous if the first transfer space region is closed counter to the direction of gravity. CO₂ pellets can then be moved only with the direction of gravity in the direction toward the delivery device.

The first transfer space region and/or the second transfer space region is preferably fluidically connected to the introduction opening. This makes it possible, in particular, to conduct excess CO₂ gas that arises when compressing the CO₂ pellets through the first transfer space region and the second transfer space region.

The second transfer space region advantageously expands in cross section counter to the direction of gravity. Due to the cross section expansion in the second transfer space region, CO₂ gas flowing counter to the direction of gravity is decelerated. It is thus achieved, in particular, that as few CO₂ pellets as possible are conveyed into the second transfer space region counter to the direction of gravity.

An exhaust gas outlet is preferably arranged or formed at the second transfer space region. In particular, CO₂ gas that exits the compressing device during the formation of the CO₂ pellets, for example due to sublimation or non-solidification, can be released through the exhaust gas outlet to an environment of the apparatus.

It is advantageous if the exhaust gas outlet fluidically connects the second transfer space region to an environment of the apparatus and if the exhaust gas outlet defines a longitudinal axis, which runs in parallel or substantially in parallel to the direction of gravity. It is thus possible, in particular, to open the second transfer space region counter to the direction of gravity by means of the exhaust gas outlet. A risk of CO₂ pellets exiting through the exhaust gas inlet in an undesired manner can thereby be reduced.

In order to prevent, in particular, CO₂ pellets from being able to exit into the environment of the apparatus through the exhaust gas outlet, it is favorable if a retaining element that is permeable to gas and impermeable to CO₂ pellets is arranged or formed at or before the exhaust gas outlet.

The apparatus can be formed in a simple manner if the retaining element is configured in the form of a grate, a net, or a perforated metal sheet. CO₂ gas is able to exit through retaining elements configured in that way, but CO₂ pellets are retained due to their size if openings in the retaining element are smaller than the CO₂ pellets.

In accordance with a further preferred embodiment of the invention, provision may be made that the apparatus comprises a separating device for separating excess CO₂ gas and CO₂ pellets and that the separating device comprises the transfer device, in particular the transfer space. With such a separating device, it is possible in a simple manner to separate CO₂ pellets and excess CO₂ gas that arises during the formation of the CO₂ pellets. For example, the CO₂ gas can be discharged to the environment of the apparatus, and the CO₂ pellets can be transferred to the delivery device as intended. In particular, as a result of the proposed further development, a compact structure of the apparatus can be achieved.

It is favorable if the separating device comprises at least one flow redirection element for redirecting a flow of excess CO₂ gas from the transfer device inlet to the collection hopper and from the collection hopper to the exhaust gas outlet. Due to the different inertia of CO₂ gas and CO₂ pellets, a separation of the two components having different densities can be achieved in a simple manner by redirecting a flow in which the excess CO₂ gas and CO₂ pellets are conducted from the compressing device to the delivery device.

The separating device favorably comprises a decelerating device for decelerating the excess CO₂ stream from the collection hopper in the direction toward the exhaust gas outlet. Such a decelerating device prevents, in particular, the excess CO₂ gas from being able to meet CO₂ pellets with high energy and accelerate said CO₂ pellets toward the exhaust gas outlet.

The apparatus can be configured in a simple and compact manner if the decelerating device comprises the second transfer space region.

Furthermore, it may be advantageous if the apparatus comprises a pellet detaching device for detaching CO₂ pellets adhering to the collection hopper. In this way, in particular, a clogging of the apparatus in the region of the collection hopper can be prevented in a simple and secure manner.

It is advantageous if the pellet detaching device comprises a gas accelerating device for accelerating the excess CO₂ gas in the direction toward the collection hopper. The gas accelerating device may, in particular, be of fluid mechanical configuration, for example by way of a narrowing of a portion of the transfer space, for example of the first transfer space region.

The gas accelerating device favorably comprises the first transfer space region. Said transfer space region may be geometrically designed such that it defines a tapering flow channel for the excess CO₂ gas and the CO₂ pellets, such that both the CO₂ gas and the CO₂ pellets are accelerated in the direction toward the collection hopper upon flowing through the first transfer space region. Thus, in particular, CO₂ pellets and CO₂ gas can be directed at or conducted to an inner face of the collection hopper, thus making it possible to detach adhering CO₂ pellets in a simple and secure manner.

In order to be able to deliver, in particular, a plurality of CO₂ pellets to the delivery device simultaneously in a defined manner, it is advantageous if the collection hopper defines an arcuate hopper outlet opening. For example, CO₂ pellets can thus be delivered into receptacles of a rotating dosing disc, for example rotating about a rotational axis extending in parallel to the direction of gravity. The receptacles on the dosing disc then all rotate at the same angular velocity.

In particular, in order to facilitate the gravitational force upon the delivery of CO₂ pellets from the collection hopper through the hopper outlet opening into the delivery device, it is advantageous if the hopper outlet opening extends transversely, in particular perpendicularly, to the direction of gravity. CO₂ pellets are thus able to fall into receptacles of the delivery device solely due to their weight, in particular even when no additional CO₂ gas stream is propelling them.

In accordance with a further preferred embodiment of the invention, provision may be made that the delivery device comprises a dosing device for dosing a number or a defined volume of CO₂ pellets before introduction into a pressurized gas stream for forming a mixed stream of the pressurized gas and CO₂ pellets. The dosing device makes it possible, in particular, to exactly predetermine the number of CO₂ pellets in a mixed stream of the pressurized gas and the CO₂ pellets, for example in order to adapt the mixed stream to a corresponding cleaning application. In particular, receptacles may be provided on the dosing device in which only individual or a predetermined number of CO₂ pellets are able to be received.

Further, the invention relates to a cleaning appliance for blasting surfaces to be treated with a mixed stream of a pressurized gas and CO₂ pellets, wherein the cleaning appliance comprises an apparatus for producing, in particular high-strength, CO₂ pellets from CO₂ snow, wherein the apparatus comprises a compressing device for compressing CO₂ snow to form CO₂ pellets and a delivery device for delivering the CO₂ pellets into a pressurized gas stream, wherein the apparatus comprises a fluid mechanical transfer device for conveying CO₂ pellets from the compressing device to the delivery device and wherein the transfer device is arranged or formed between the compressing device and the delivery device.

Configuring a cleaning appliance in the proposed manner then has the advantages that have already been described above in connection with preferred embodiments of apparatuses for producing CO₂ pellets from CO₂ snow.

It is favorable if the cleaning appliance comprises a CO₂ connection for connecting to a CO₂ store containing liquid CO₂ or comprises a CO₂ store containing liquid CO₂. With such a cleaning appliance, it is possible, in particular, to produce CO₂ pellets exactly when they are needed for a cleaning application. Thus, CO₂ pellets do not have to be separately procured and complexly stored, in particular cooled, but instead CO₂ pellets can be directly produced from liquid CO₂. In particular, the liquid CO₂ can be used to form CO₂ snow, which is then compressed with a compressing device to form CO₂ pellets.

Furthermore, it is favorable if the cleaning appliance comprises a pressurized gas connection for connecting to a pressurized gas generating device or comprises a pressurized gas generating device for generating a pressurized gas stream of a pressurized gas. In this way, a pressurized gas stream can be produced, into which CO₂ pellets can be introduced for forming a mixed stream that comprises pressurized gas and CO₂ pellets.

In order to be able to have CO₂ pellets strike an object to be cleaned at high speed, it is favorable if the cleaning appliance comprises a CO₂ pellet accelerating device for accelerating CO₂ pellets.

It is advantageous if the CO₂ pellet accelerating device comprises a pressurized gas conduit that is in fluidic connection with the pressurized gas connection or the pressurized gas generating device. This configuration makes it possible, in particular, to accelerate CO₂ pellets, for example, in a direction transverse, in particular perpendicular, to the pressurized gas flow by acting upon them with a pressurized gas or by introducing them into a pressurized gas stream.

It is favorable if the delivery device and/or the CO₂ pellet accelerating device comprises at least one venturi nozzle. Using a venturi nozzle, a gas stream can be accelerated, in particular for accelerating particles, for example CO₂ pellets.

It is advantageous if a blasting connection is arranged or formed downstream from the delivery device for connecting to a blasting conduit or if the delivery device downstream is in fluidic connection with a blasting conduit. This makes it possible, in particular, to conduct a mixed stream of pressurized gas and CO₂ pellets to an object to be cleaned in a defined manner.

In order to be able to clean an object to be cleaned with high precision, it is advantageous if a blasting nozzle is arranged or formed on a free end of the blasting conduit.

In accordance with a further preferred embodiment of the invention, provision may be made that the cleaning appliance comprises a CO₂ pellet intermediate store for intermediately storing the produced CO₂ pellets. Such a configuration has the advantage, in particular, that even in a non-continuous, i.e. in particular intermittent operation of the apparatus for producing CO₂ pellets, a continuous delivery of CO₂ pellets with the delivery device to the pressurized gas stream is made possible by the CO₂ pellet intermediate store.

The cleaning appliance can be configured in a simple and compact manner if the transfer device comprises the CO₂ pellet intermediate store. In particular, CO₂ pellets can be intermediately stored in the collection hopper of the transfer device.

Further, the invention relates to a method for producing, in particular high-strength, CO₂ pellets from CO₂ snow, in particular for a cleaning appliance for blasting surfaces to be treated with a mixed stream of a pressurized gas and CO₂ pellets, in which method CO₂ snow is compressed to form CO₂ pellets, wherein the formed CO₂ pellets are fluid mechanically transferred for delivery or introduction into a pressurized gas stream.

The proposed approach for transferring CO₂ pellets makes it possible, in particular, to also easily detach CO₂ pellets that are adhering to walls or surfaces of the cleaning appliance or of an apparatus for producing CO₂ pellets.

In order to be able to, in particular, minimize a number of moving parts on a cleaning appliance or an apparatus for producing CO₂ pellets, it is advantageous if the CO₂ pellets are fluid mechanically transferred with excess CO₂ gas. Excess CO₂ gas can arise, in particular, during the production of CO₂ pellets from liquid CO₂, which can thus be used, in particular, to transfer the CO₂ pellets after their formation, in particular to a location where they are delivered or introduced into a pressurized gas stream.

The excess CO₂ gas is preferably accelerated during the fluid mechanical transfer of the CO₂ pellets. The CO₂ pellets can also be accelerated in this way. In addition, the CO₂ gas can, for example, strike adhering CO₂ pellets at higher speed in order to detach them from inner surfaces of a cleaning appliance or of an apparatus for producing CO₂ pellets.

Furthermore, it is advantageous if the excess CO₂ gas is separated, in particular fluid mechanically, from the CO₂ pellets before the delivery or introduction of the CO₂ pellets into the pressurized gas stream. By way of a fluid mechanical separation, it is possible, in particular, to separate CO₂ gas and CO₂ pellets from one another without moving components, for example by forming a flow path that is able to securely and simply separate components of a mixed stream by virtue of their different densities using corresponding directional changes.

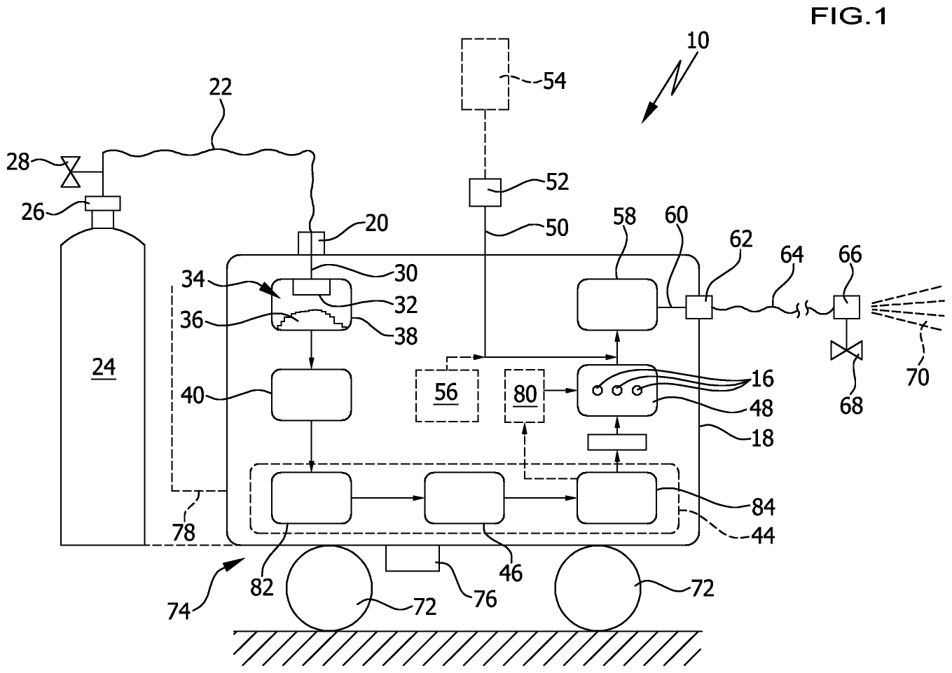

Schematically depicted in FIG. 1 is an embodiment of a cleaning appliance, denoted as a whole with the reference numeral 10, for blasting surfaces to be treated with a mixed stream 12 of a pressurized gas 14 and CO₂ pellets 16.

The cleaning appliance 10 comprises a housing 18 on which a CO₂ connection 20 is arranged, which is connected by way of a CO₂ conduit 22 to a CO₂ store 24, for example in the form of a CO₂ pressurized gas cylinder. In particular, it may contain liquid CO₂. Arranged downstream from an outlet 26 of the CO₂ store is a valve arrangement 28 comprising at least one valve in order to conduct liquid CO₂ from the CO₂ store 24 through the CO₂ conduit 22.

The CO₂ connection 20 is in fluidic connection with an expansion nozzle 32 of an expansion device 34 by way of a connecting conduit 30. The liquid CO₂ is expanded by the expansion nozzle 32 and forms CO₂ snow 36, which is collected in a receiving container 38.

Optionally, the cleaning appliance may further comprise a separating device 40 in order to separate the produced CO₂ snow 36 from non-solidified CO₂ gas.

The cleaning appliance 10 further comprises an apparatus 42 for producing CO₂ pellets 16 from CO₂ snow 36, which comprises a compressing device 44 for compressing CO₂ snow 36 to form CO₂ pellets 16. The compressing device 44 is configured in the form of a gear compressor 46.

The formed CO₂ pellets 16 are delivered to a transfer device 47, which transfers the CO₂ pellets 16 to a delivery device 48. The delivery device 48 is in fluidic connection with a pressurized gas connection 52 by way of a pressurized gas conduit 50. Said compressed gas connection 52 can be connected to an external pressurized gas source 54, which provides pressurized gas, for example pressurized air. Optionally, the cleaning appliance 10 may also comprise a pressurized gas source 56, for example a pressurized air cylinder or a compressor for producing pressurized air with a desired pressure.

After the delivery device 48, a mixed stream is formed by the pressurized gas and the CO₂ pellets 16 introduced therein. By means of the accelerating device 58, which in one embodiment comprises a venturi nozzle, the CO₂ pellets 16 are accelerated by the pressurized gas stream.

The accelerating device 58 is in fluidic connection with a blasting connection 62 arranged downstream by way of a conduit 60. A blasting conduit 64 can be optionally connected to the blasting connection 62 or be permanently connected thereto.

Arranged on a free end of the blasting conduit 64 is, in one embodiment, a blasting nozzle 66, which optionally comprises a valve 68 for regulating the shape and/or strength of the particle jet 70 exiting the blasting nozzle 66.

In one embodiment, the cleaning appliance 10 is of mobile configuration and has a chassis 74 comprising at least three wheels 72. In one embodiment, the cleaning appliance 10 comprises a drive 76 for driving at least one wheel 72 of the chassis 74.

Furthermore, in one embodiment of the cleaning appliance 10, a holding device 78 is provided for accommodating one or more CO₂ stores 24. Overall, in one embodiment, the cleaning appliance can be configured such that it is able to be operated completely independently of external power and CO₂ supplies or pressurized gas sources.

Optionally, in one embodiment, an intermediate store 80 for CO₂ pellets is arranged or formed between the compressing device 44 and the delivery device 48.

The compressing device 44 also comprises, in particular, a delivery device 82 for delivering CO₂ snow 36 from the expansion device 34 or the separating device 40 to the gear compressor 46.

In one embodiment, the compressing device 44 comprises an extruding device 84 for extruding the CO₂ pellets 16.

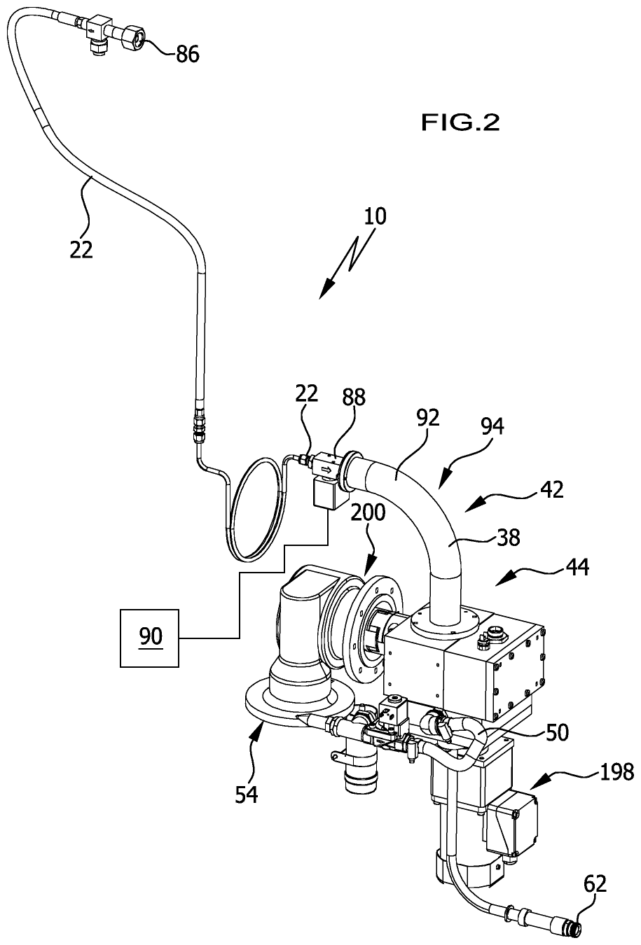

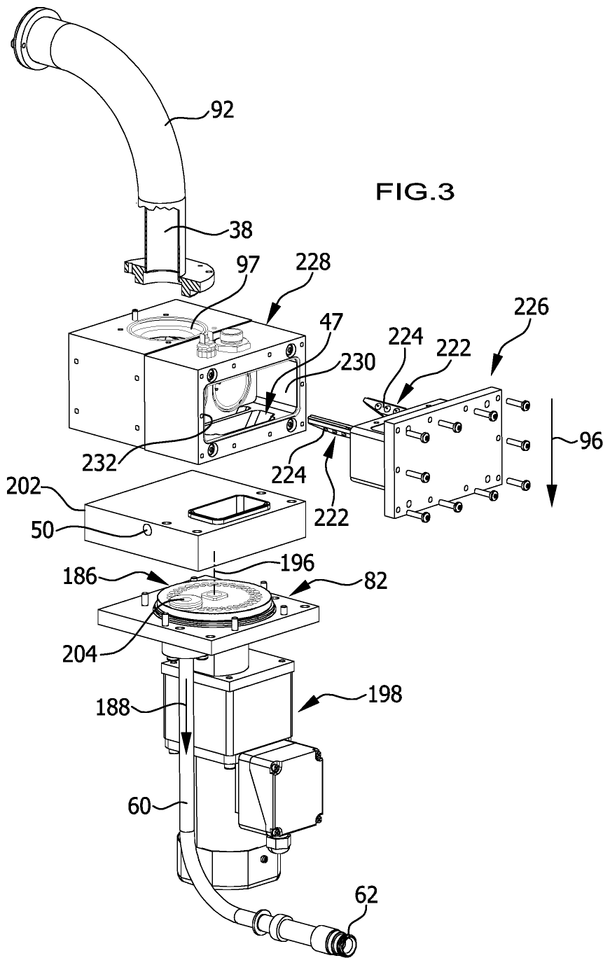

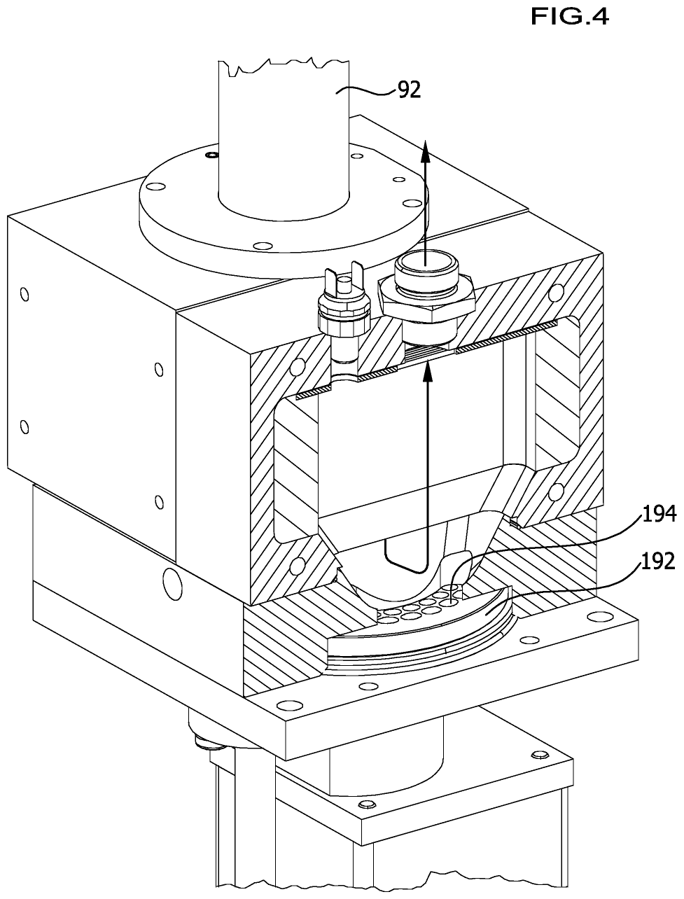

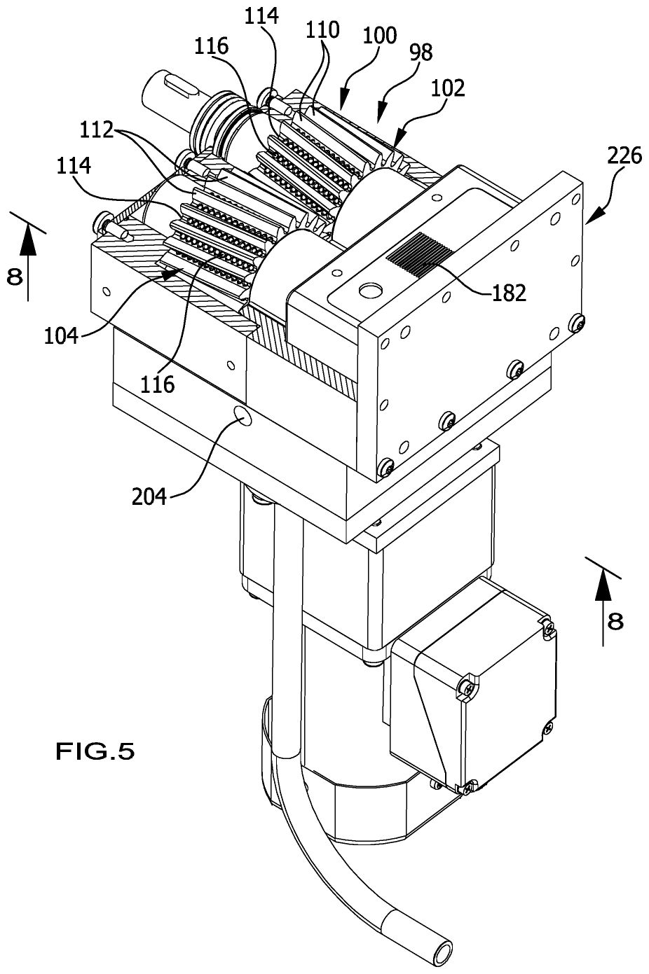

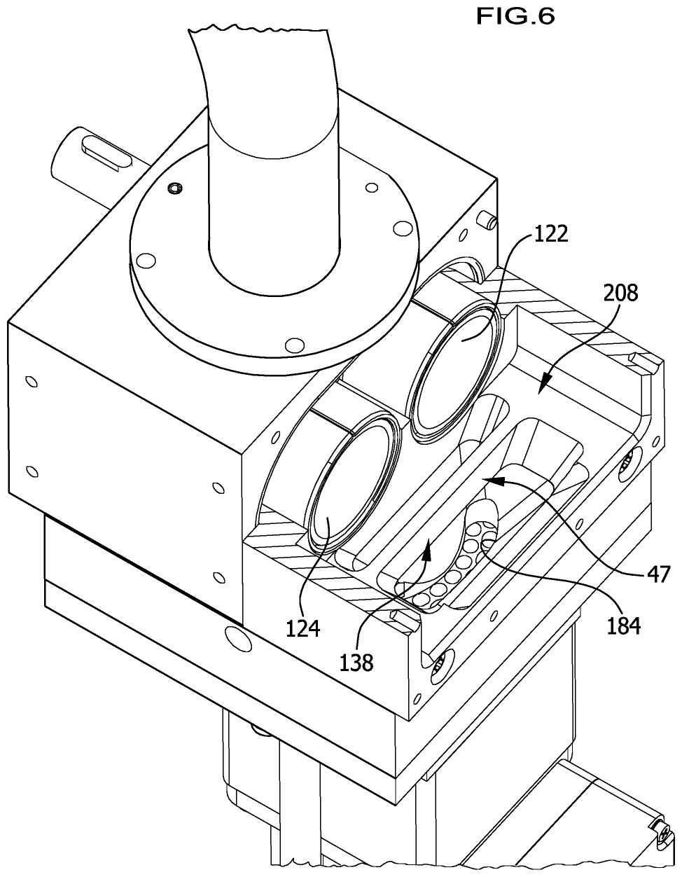

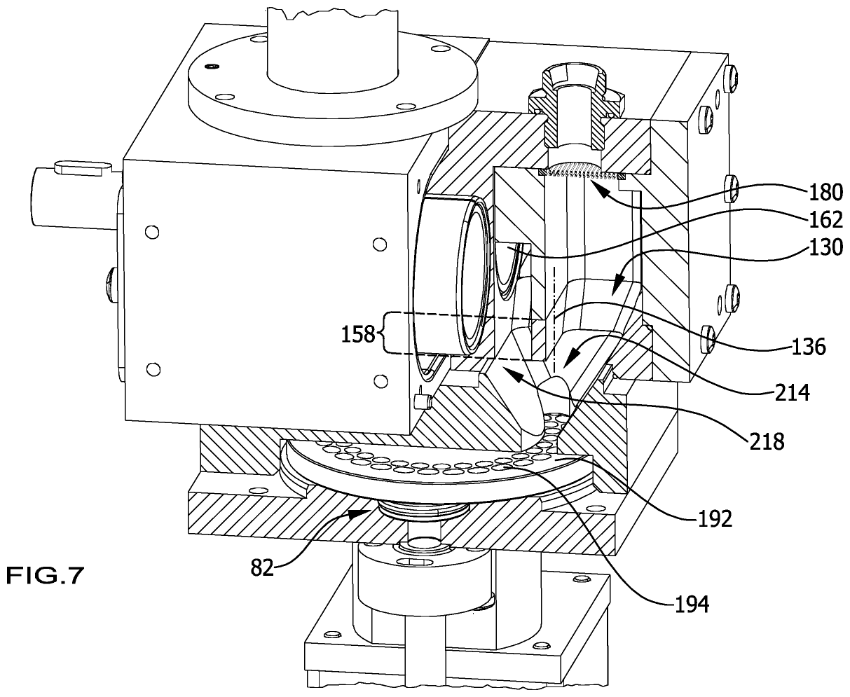

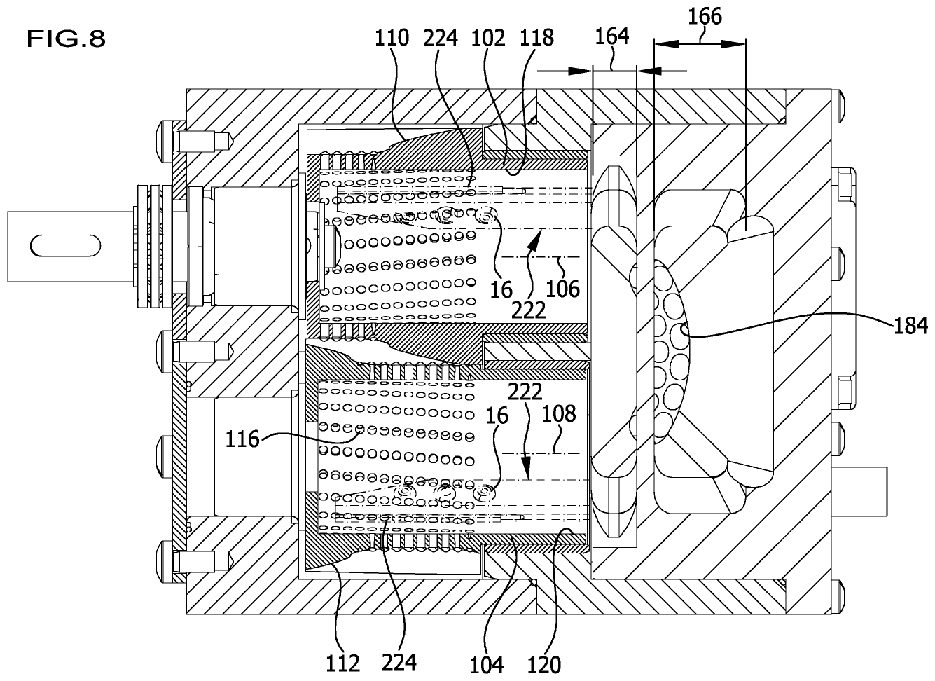

A further embodiment of a cleaning appliance 10 with an apparatus 42 for producing CO₂ pellets 16 from CO₂ snow 36 is schematically depicted in part in FIGS. 2 to 9. The same reference numerals have been used in this embodiment as in the embodiment of FIG. 1 for denoting identical or similar components.

A free end 86 of a CO₂ conduit 22 is fluidically connected to a valve 88. The end 86 can be connected to a CO₂ store 24, for example.

The valve 88 is controllable by way of a controlling and/or regulating device 90 of the apparatus 42, which is not depicted in more detail, and can be opened and closed in a defined manner.

Arranged downstream from the valve 88 is an expansion nozzle 32, through which liquid CO₂ is able to flow into a curved pipe 92 of the expansion device 34. The pipe 92 forms part of a fluid mechanical pre-compression device 94, in which CO₂ snow formed due to an expansion of the liquid CO₂ flowing out of the expansion nozzle 32 is pre-compressed and collected. The pipe 92 thus also serves, in particular, as a receiving container 38.

The receiving container 38 opens relative to the direction of gravity symbolized schematically by the arrow 96 into a main compressor inlet 97 of a main compressor 98 of the compressing device 44, which is configured in the form of a gear compressor 100.

The gear compressor 100 comprises two cooperating compressor sleeves 102 and 104, the longitudinal axes 106 and 108 of which extend in parallel to one another and perpendicularly to the direction of gravity. The compressor sleeves 102 and 104 each comprise a plurality of radially outwardly projecting teeth 110 and 112, respectively, between which snow receptacles 114 are formed. At the base of the snow receptacles 114, formed in the compressor sleeves 102 and 104 are a plurality of perforations 116, which point in the radial direction relative to the longitudinal axes 106 and 108 and through which CO₂ snow is pressed with the teeth 110, 112 of the respective other compressor sleeve 102, 104 into a respective inner space 118 and 120 of the respective compressor sleeves 102 and 104.

A respective scraping element 222 is arranged in each of the inner spaces 118 and 120. The scraping elements 222 configured in the form of elongate projections each have a scraping edge 224, which extends in parallel to the respective longitudinal axis 106 and 108. The scraping edges abut against inner wall faces of the compressor sleeves 102 and 104. Each perforation 116 is moved past the associated scraping edge 224 once per revolution of the compressor sleeves 102 and 104. The CO₂ strands pressed through the perforations 116 are hereby scraped off, thereby producing short rod-shaped CO₂ pellets 16 of substantially equal length and equal density with a constant rotational speed of the compressor sleeves 102 and 104 and consistent quality of the CO₂ snow to be compressed.

The rod-shaped CO₂ pellets 16 are moved to the respective compressor sleeve outlet 122 and 124 of the respective compressor sleeves 102 and 104 due to the rotation of the compressor sleeves 102 and 104, which are open only on one side.

The scraping elements 222 are arranged on a support block 226, which is inserted into a receiving box 228. The receiving box 228 defines a space 230 into which the compressor sleeve outlets 122 and 124 open. During assembly, the support block 226 is slid in through an opening 232 of the receiving box 228 located opposite the compressor sleeve outlets 122 and 124.

The compressor sleeve outlets 122 and 124 together form a compressing device outlet 126, which is in fluidic connection with a transfer device inlet 128 of the transfer device 47.

The transfer device 47 is configured in the form of a fluid mechanical transfer device 47 for conveying CO₂ pellets 16 from the compressing device 44 to the delivery device 82. It is arranged or formed between the compressing device 44 and the delivery device 82.

The transfer device 47 comprises a transfer space 130, which is arranged or formed between the compressing device outlet 126 and an introduction opening 132 of a collection hopper 134. The support block 226 delimits the transfer space 130 in sections.

The transfer device 47 comprises the collection hopper 134. The latter tapers in cross section in the direction toward the delivery device 82. During the intended use of the apparatus 42 or the cleaning appliance 10, a hopper axis 136 of the collection hopper 134 extends in parallel to the direction of gravity. The collection hopper 134 thus tapers in the direction of gravity.

The transfer space 130 is subdivided by a dividing element 138 into a first transfer space region 140 and a second transfer space region 142.

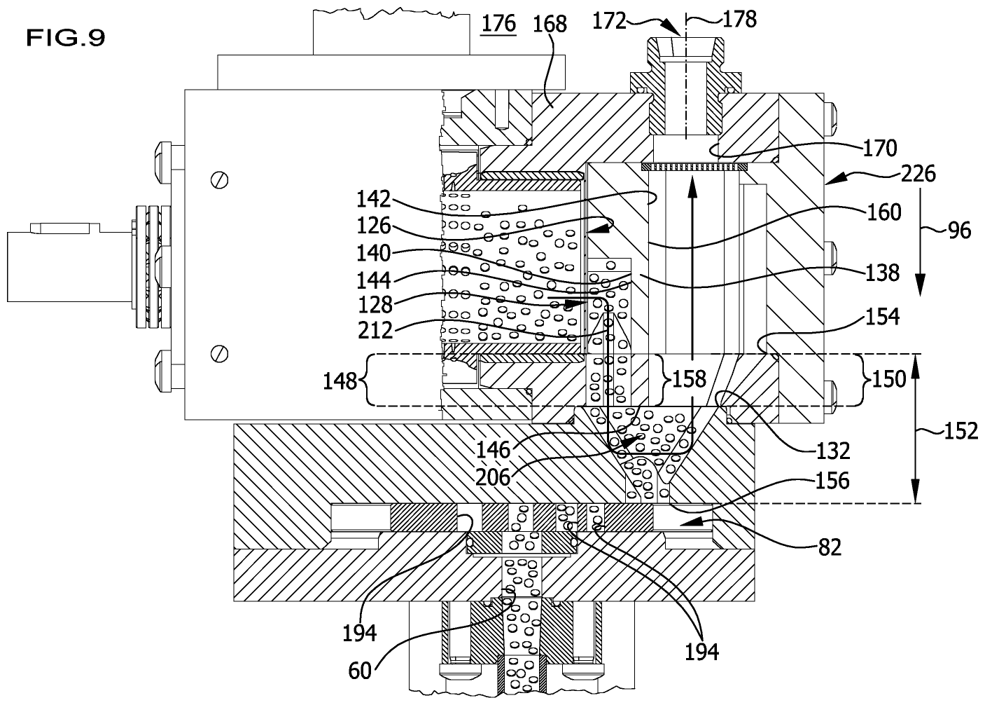

The dividing element 138 defines a first dividing element side face 144, which points in the direction toward the compressing device outlet 126 and laterally delimits the first transfer space region 140. The first dividing element side face 144 extends, as can be easily seen in particular in FIG. 9, in parallel to the direction of gravity 96.

The dividing element 138 reaches with an end edge 146 extending transversely to the direction of gravity up to the introduction opening 132 of the collection hopper 134.

Lower end regions 148 and 150 of the first transfer space region 140 and the second transfer space region 142, respectively, also taper in cross section somewhat in the direction toward the introduction opening 132.

If the end regions 148 and 150 are seen as part of the collection hopper 134, the dividing element 138 dips with its lower part relative to the direction of gravity, thus with the end edge 146, somewhat into the collection hopper 134.

The collection hopper 134, which comprises the end regions 148 and 150, defines a hopper height 152, which extends from a hopper opening 154 of the collection hopper 134 with the end regions 148 and 150 that define the greatest cross section of the collection hopper 134 up to a collection hopper outlet 156 that defines the smallest cross section of the collection hopper 134. A relative immersion depth 158 of the dividing element 138 into the collection hopper 134 commencing from the hopper opening 154 is in a range of about 10% to about 50% relative to the hopper height 152. In particular, in one embodiment, it is in a range of about 20% to about 40%. In the embodiment depicted in the Figures, the ratio between the relative immersion depth 158 and the hopper height 152 is about 1:3.

A second dividing element side face 160 extends in parallel to the first dividing element side face 144 and points in the opposite direction relative thereto. The second dividing element side face 160 delimits the second transfer space region 142.

The first transfer space region 140 is closed counter to the direction of gravity, namely by a transverse face 162 extending transversely to the direction of gravity.

The transfer space regions 140 and 142 are of substantially cuboidal configuration above the end regions 148 and 150 in the direction of gravity. The widths 164 and 166 of the respective transfer space regions 140 and 142 have a ratio of about 1:2. The widths 164 and 166 are defined both perpendicularly to the respective dividing element side faces 144 and 160 and perpendicularly to the direction of gravity.

Furthermore, the second transfer space region 142 extends counter to the direction of gravity to a total height that is about twice as high as a height of the first transfer space region 140.

In the described manner, both transfer space regions 140 and 142 are fluidically connected to the hopper opening 154 and to the introduction opening 132.

As described, the transfer space 130 tapers in sections in the direction of gravity, namely in the end regions 148 and 150 of the respective transfer space regions 140 and 142, and comprises an upper part of the collection hopper 134 relative to the direction of gravity.

As described, the first transfer space region 140 tapers in the end region 148 in the direction toward the collection hopper 134. This also applies accordingly to the second transfer space region 142 in the end region 150. The second transfer space region 142 therefore expands in cross section, namely in the end region 150, counter to the direction of gravity.

In a wall 168 located opposite to the collection hopper 134, which delimits the second transfer space region 142 counter to the direction of gravity, a perforation 170 configured as a bore is formed, into which a sealed off outlet connector 172 is inserted. The perforation 170 forms an exhaust gas outlet 174 arranged or formed at the second transfer space region 142. It fluidically connects the second transfer space region 142 to an environment 170 of the apparatus 42. Furthermore, the exhaust gas outlet 174 defines a longitudinal axis 178, which extends in parallel to the direction of gravity.

A retaining element 180 is arranged at or before the exhaust gas outlet 174. It is configured to be permeable to gas, but impermeable to CO₂ pellets 16.

In the embodiment depicted in FIGS. 2 to 9, the retaining element 180 is configured in the form of a grate 182. Slits in the grate 182 are narrower than a smallest dimension of the CO₂ pellets that can be produced with the apparatus 42. In alternative embodiments, the retaining element 180 is configured in the form of a net or a perforated metal sheet.

The collection hopper outlet 156 of the collection hopper 134 is configured in the form of an arcuate hopper outlet opening 184. It extends transversely to the direction of gravity.

The delivery device 82 comprises a dosing device 186 for dosing a number or a defined volume of CO₂ pellets 16 before introduction into a compressed gas stream schematically depicted by the arrow 188 for forming a mixed stream 190 of the pressurized gas and CO₂ pellets 16.

The dosing device 186 comprises a dosing disc 192 with a plurality of dosing receptacles 194. The dosing disc 192 is driven by a drive 198 about a rotational axis 196 extending in parallel to the direction of gravity.

The dosing disc 192 interrupts the pressurized gas stream, which accelerates the CO₂ pellets 16, which are accommodated in dosing receptacles 194 configured in the form of perforations in the dosing disc 192, into the conduit 160.

In the embodiment depicted in FIGS. 2 to 9, a compressor that is driven by a drive 200 of the gear compressor 110 is provided as a pressurized gas source 54. A pressurized gas conduit fluidically connects the pressurized gas source 54 to a housing part 202 in which a curved fluid channel 204 is formed, which has an end that ends above the dosing disc 192 and is oriented in alignment with the conduit 60.

In the depicted embodiment, the conduit 60 is curved and ends in the blasting connection 62, which points in the direction transverse to the direction of gravity.

The cleaning appliance 10 further comprises an intermediate store 206 for intermediately storing produced CO₂ pellets 16. In the embodiment schematically depicted in the Figures, the transfer device 47 comprises the intermediate store 206.

The apparatus 42 described above further comprises a separating device 208 for separating excess CO₂ gas and CO₂ pellets formed with the compressing device 44. Excess CO₂ gas exits the compressor sleeve outlets 122 and 124 and flows into the first transfer space region 140 of the transfer space 130. The excess CO₂ gas is gaseous CO₂ that was not solidified during the expansion of the liquid CO₂ in the pre-compression device 94 as well as CO₂ gas that formed due to sublimation in the region of the compressing device 44 when the CO₂ pellets 16 are heated.

The separating device 208 comprises a flow redirection element 210 for redirecting a flow 212, as it is schematically shown in FIG. 9, from the transfer device inlet 128 to the collection hopper 134 and from here to the exhaust gas outlet 174. The flow 212 is also further redirected at suitable side faces of the collection hopper 134, such that the collection hopper 134 forms a further flow redirection element.

The separating device 208 comprises a decelerating device 214 for decelerating the flow 212 from the collection hopper 134 in the direction toward the exhaust gas outlet 174. The decelerating device 224 comprises the second transfer space region 142, namely, in particular, the end region 150 thereof, which expands in cross section commencing from the collection hopper 134 in the direction toward the exhaust gas outlet 174. Due to the expansion of the CO₂ stream thus made possible, it decelerates. CO₂ pellets 16 can then no longer be entrained by the flow 212 in the direction toward the exhaust gas outlet 174, but instead fall in the direction toward the hopper outlet opening 184 due to their weight.

Furthermore, the apparatus 42 comprises a pellet detaching device 216 for detaching CO₂ pellets adhering to the collection hopper 134.

The pellet detaching device 216 comprises the first transfer space region 140, namely in particular the dividing element 138 with the end region 148, which define a constriction 218 in the region of the end edge 146. In this region, the flow 212 has the highest flow speed. Excess CO₂ gas then flows at a speed that is sufficient to detach adhering CO₂ pellets 16 from an inner face of the collection hopper 134, or to have CO₂ pellets strike adhering CO₂ pellets 16 at a speed that is sufficient to detach them from the collection hopper 134.

The pellet detaching device 216 thus comprises a gas accelerating device 220 for accelerating the excess CO₂ gas in the direction toward the collection hopper 134. The gas accelerating device 220 is of fluid mechanical configuration and comprises, in particular, the constriction 218 in the region of the first transfer space region 140.

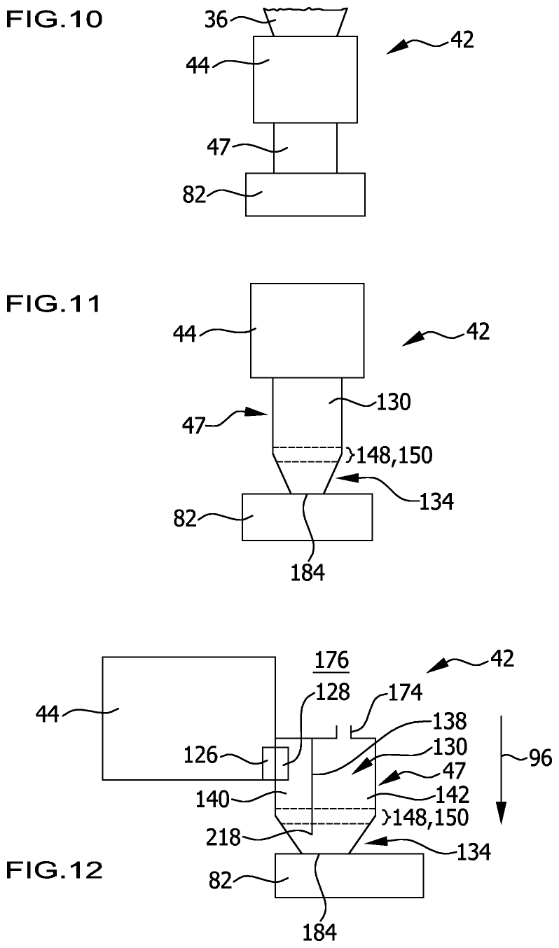

Schematically depicted in FIG. 10 is a further embodiment of an apparatus for forming CO₂ pellets 16 from CO₂ snow 36. Here, the transfer device 47 is arranged or formed between the compressing device 44 and the delivery device 82 both spatially and fluid mechanically.

In the embodiment schematically depicted in FIG. 11, the transfer device 47 is depicted in somewhat more detail. Here, the transfer space 130 is schematically depicted, which defines tapering end regions 148 and 150 that transition into the collection hopper 134. The collection hopper 134 opens with the hopper outlet opening 184 into the delivery device 82.

A further embodiment of an apparatus 42 is schematically depicted in FIG. 12. Here, the compressing device 44 comprises a compressing device outlet 126, which is open transversely to the direction of gravity and is in fluidic connection with a transfer device inlet 128 of the transfer device 47.

The transfer space 130 is subdivided by a dividing element 138 into a first transfer space region 140 and a second transfer space region 142.

The dividing element 138 dips with an end pointing in the direction of gravity into the collection hopper 134. Here, too, the hopper outlet opening 184 of the collection hopper 134 opens into the delivery device 82.

The exhaust gas outlet 174 is arranged at the second transfer space region 142 opposite to the hopper outlet opening 184 counter to the direction of gravity and fluidically connects the second transfer space region 142 to an environment 176 of the apparatus 42.

The constriction 218 is defined between a front end of the dividing element 138, which dips somewhat into the collection hopper 134, and a conical inner wall face of the collection hopper 134. Due to the narrowing in the region of the constriction 218, a flow of excess CO₂ gas is accelerated from the transfer device inlet 128 in the direction toward the hopper outlet opening 184. CO₂ pellets 16 adhering to the inner face of the collection hopper 134 can thus be detached in a simple manner.

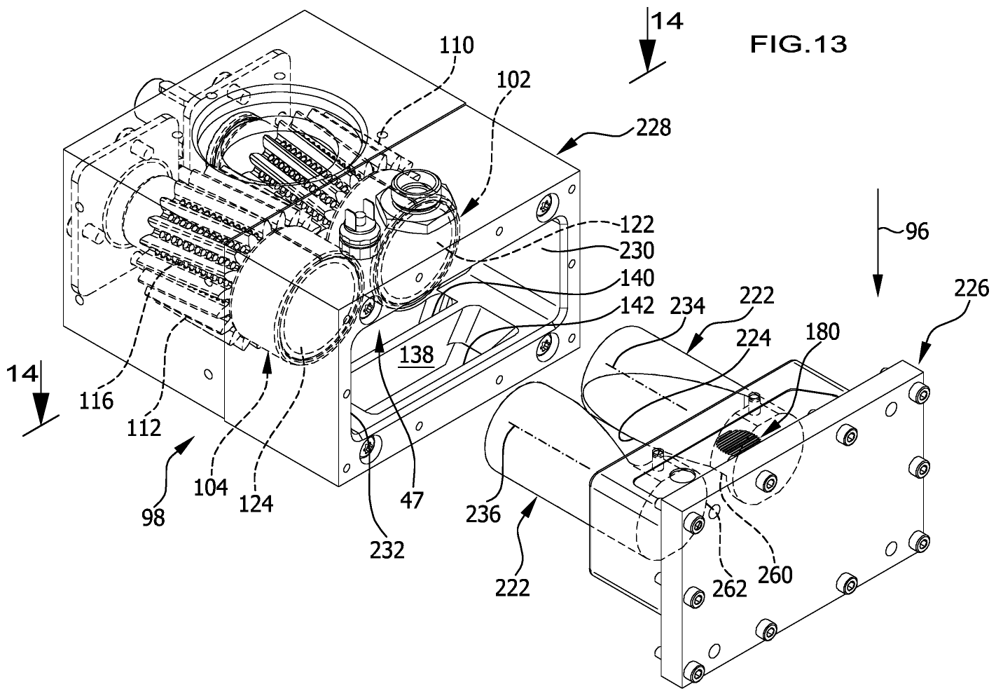

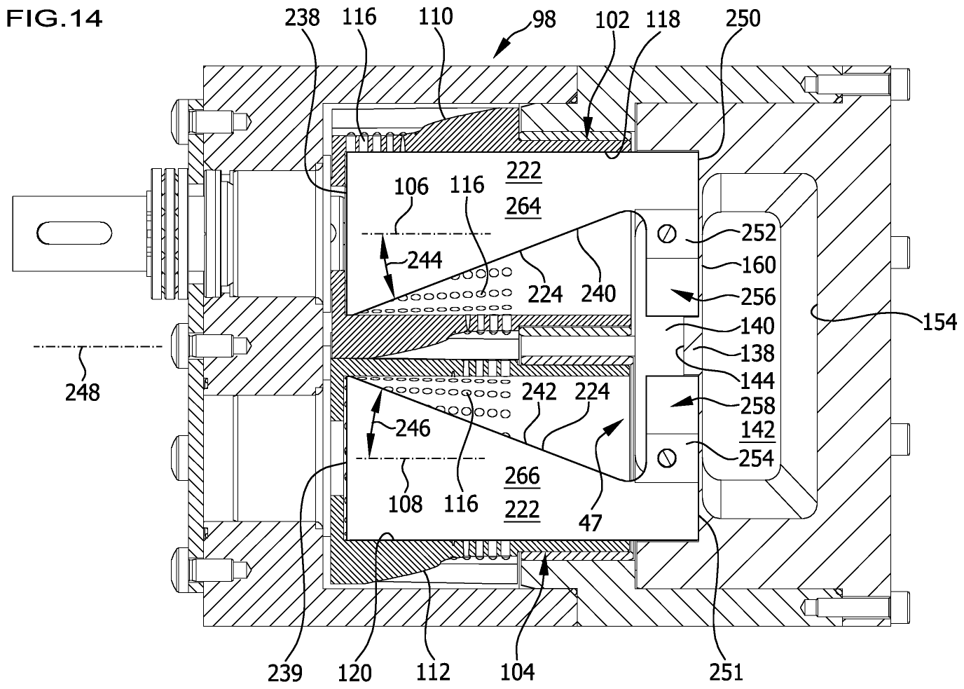

An alternative embodiment of a main compressor 98 is schematically depicted in FIGS. 13 and 14. It differs from the main compressor 98 described in connection with FIGS. 2 to 9 substantially in the configuration of the scraping elements 222. The cleaning appliance 10 can be optionally equipped with one of the two main compressors 98.

The scraping elements 222 of the alternative embodiment are arranged on the support block 226 and define a cylindrical outer contour. Longitudinal axes 234 and 236 of the two scraping elements 222 coincide with the respective longitudinal axes 106 and 108. End faces 238 and 239 of the two scraping elements 222 inserted into the inner spaces 118 and 120, respectively, are of circular configuration.

The scraping elements 222 formed from a solid cylindrical base body are beveled commencing from the circular end faces 238. The planar oblique faces 240 and 242 configured in this way enclose with the respective longitudinal axis 106 and 108 a respective wedge angle 244 and 246. The two oblique faces 240 and 242 of the two scraping elements 222 extend in parallel to the direction of gravity, symbolized by the arrow 96. The two scraping elements 222 are formed mirror symmetrical to one another relative to a midplane 248 of the main compressor 98. The midplane 248 extends in parallel to the longitudinal axes 106 and 108 in the middle between them and in parallel to the direction of gravity 96.

Two further end faces 250 and 251 of the two scraping elements 222 are also of circular configuration. The end faces 238, 239 and 250, 251 point in opposite directions and perpendicularly to the respective longitudinal axes 106 and 108.

The oblique faces 240 and 242 extend over approximately ⅚ of a total length of the two scraping elements in parallel to the respective longitudinal axes 106 and 108. On about ⅙ of their total length commencing from the end faces 250 and 251, the scraping elements 222 are configured in the form of disc-shaped end bodies 256 and 258.

Pointing counter to the direction of gravity 96, the two end bodies 256 and 258 are each provided with a respective flattened portion 252 and 254. The flattened portions 252 and 254 extend transversely to the direction of gravity 96 and point in a direction counter to the direction of gravity 96.

Furthermore, the end bodies 256 and 258 are each provided with a respective set-back portion 260 and 262 on their side pointing toward the oblique faces 240 and 242. The set-back portions 260 and 262 extend from a lower side of the scraping body 222 in the direction of gravity and from sides pointing toward one another into the respective end body 256 and 258 and thus delimit the first transfer space region 140. The side faces of the end bodies 256 and 258 pointing toward the end faces 238 and 239 form part of the dividing element 138 or part of the first dividing element side face 144.

The oblique faces 240 and 242 define intersection lines with respective outer jacket surfaces 264 and 266 of the two scraping elements 222. The intersection line of the scraping elements 222 that extends at the bottom relative to the direction of gravity forms a scraping edge 224 for the CO₂ strands pressed through the perforations 116. In an analogous manner to the scraping edges 224 of the scraping elements 222 of the embodiment in FIGS. 2 to 9, the CO₂ strands are scraped off, thereby forming CO₂ pellets 16 of a defined length.

The particular configuration of the scraping elements 222 of the embodiment of FIGS. 13 and 14 defines in the two compressor sleeves 102 and 104 cavities expanding in the direction toward the compressor sleeve outlets 122 and 124. In particular, the cooperation of the rotating compressor sleeves 102 and 104 with the specially designed scraping elements 222 forces a conveyance of the CO₂ pellets 16 accommodated in the inner spaces 118 and 120 toward the compressor sleeve outlets 122 and 124.

Furthermore, the configurations of the end bodies 256 and 258 serve to optimize the guidance of the CO₂ pellets 16 and excess CO₂ gas into the first transfer space region 140 and in the direction toward the collection hopper 134. Therefore, the two scraping elements 222 lead to an optimization of the transfer device 47, in particular with respect to a transport of the CO₂ pellets 16 from the inner spaces 118 and 120 to the collection hopper 134 and of the CO₂ gas flowing out of the main compressor 98.

In all other respects, the support block 226 is of identical configuration to the support block 226 of the embodiment in FIGS. 2 to 9, resulting in otherwise the same function for the transfer device 47 of the embodiment in FIGS. 13 and 14 as in the embodiment in FIGS. 2 to 9.

All embodiments of transfer devices 47 described above are configured in the form of fluid mechanical transfer devices 47. Here, a flow of excess CO₂ gas is redirected without moving parts and is accelerated in the desired manner.

With the apparatuses 42 described above, in particular, a method for producing CO₂ pellets 16 from CO₂ snow 36 can be performed. In this method, CO₂ snow 36 is compressed to form CO₂ pellets. The formed CO₂ pellets 16 are fluid mechanically transferred in order to be delivered or introduced into a pressurized gas stream 188. The fluid mechanical transfer is achieved by way of the excess CO₂ gas. It is accelerated, namely in the region of the constriction 218 as described above by way of example.

The excess CO₂ gas is separated, namely fluid mechanically, from the CO₂ pellets 16 before the delivery or introduction of the CO₂ pellets 16 into the pressurized gas stream 118. In particular, in the apparatus 42, corresponding flow redirection elements 210 like the dividing element 138 and the collection hopper 134 may serve this purpose.

The embodiments described above of apparatuses 42 for producing CO₂ pellets 16 enable a reliable operation, because the transfer device 47 is configured, in particular, to prevent, in particular, CO₂ pellets 16 from adhering in the region of the collection hopper 134 and to detach adhering CO₂ pellets 16, as the case may be. The fluid mechanical configuration of the transfer device 47 enables a constructively simple and compact structure of the apparatus 42.

### REFERENCE NUMERAL LIST

10 cleaning appliance
12 mixed stream
14 pressurized gas
16 CO₂ pellets
18 housing
20 CO₂ connection
22 CO₂ conduit
24 CO₂ store
26 outlet
28 valve arrangement
30 connecting conduit
32 expansion nozzle
34 expansion device
36 CO₂ snow
38 receiving container
40 separating device
42 apparatus
44 compressing device
46 gear compressor
47 transfer device
48 delivery device
50 pressurized gas conduit
52 pressurized gas connection
54 pressurized gas source
56 pressurized gas source
56 accelerating device
60 conduit
62 blasting connection
64 blasting conduit
66 blasting nozzle
68 valve
70 particle jet
72 wheel
74 chassis
76 drive
78 holding device
80 intermediate store
82 delivery device
84 extruding device
86 end
88 valve
90 control and/or regulating device
92 pipe
94 pre-compression device
96 arrow
97 main compressor inlet
98 main compressor
100 gear compressor
102 compressor sleeve
104 compressor sleeve
106 longitudinal axis
108 longitudinal axis
110 tooth
112 tooth
114 snow receptacle
116 perforation
118 inner space
120 inner space
122 compressor sleeve outlet
124 compressor sleeve outlet
126 compressing device outlet
128 transfer device inlet
130 transfer space
132 introduction opening
134 collection hopper
136 hopper axis
138 dividing element
140 first transfer space region
142 second transfer space region
144 first dividing element side face
146 end edge
148 end region
150 end region
152 hopper height
154 hopper opening
156 collection hopper outlet
158 immersion depth
160 second dividing element side face
162 transverse face
164 width
166 width
168 wall
170 perforation
172 outlet connector
174 exhaust gas outlet
176 environment
178 longitudinal axis
180 retaining element
182 grate
184 hopper outlet opening
186 dosing device
188 arrow
190 mixed stream
192 dosing disc
194 dosing receptacle
196 axis of rotation
198 drive
200 drive
202 housing part
204 fluid channel
206 intermediate store
208 separating device
210 flow redirection element
212 flow
214 decelerating device
216 pellet detaching device
218 construction
220 gas accelerating device
222 scraping element
224 scraping edge
226 support block
228 receiving box
230 space
232 opening
234 longitudinal axis
236 longitudinal axis
238 end face
239 end face
240 oblique face
242 oblique face
244 wedge angle
246 wedge angle
248 midplane
250 end face
251 end face
252 flattened portion
254 flattened portion
256 end body
258 end body
260 set-back portion
262 set-back portion
264 jacket surface
266 jacket surface

What is claimed is:

1. An apparatus for producing, in particular high-strength, CO₂ pellets from CO₂ snow, in particular for a cleaning appliance for blasting surfaces to be treated with a mixed stream of a pressurized gas and CO₂ pellets, wherein the apparatus comprises a compressing device for compressing CO₂ snow to form CO₂ pellets and a delivery device for delivering the CO₂ pellets into a pressurized gas stream, wherein the apparatus comprises a fluid mechanical transfer device for conveying CO₂ pellets from the compressing device to the delivery device and wherein the transfer device is arranged or formed between the compressing device and the delivery device.

2. The apparatus in accordance with claim 1, wherein the transfer device has a transfer device inlet, wherein the compressing device has a compressing device outlet, and wherein the compressing device outlet and the transfer device inlet are fluidically connected to one another.

3. The apparatus in accordance with claim 1, wherein the transfer device comprises a collection hopper and wherein the collection hopper tapers in cross section in the direction toward the delivery device,
wherein, in particular, at least one of
a) the collection hopper during the intended use of the apparatus is oriented in parallel or substantially in parallel to the direction of gravity and tapers in the direction of gravity
and
b) an introduction opening of the collection hopper is arranged or formed below the compressing device outlet relative to the direction of gravity.

4. The apparatus in accordance with claim 3, wherein the transfer device comprises a transfer space and wherein the transfer space is arranged or formed between the compressing device outlet and the introduction opening,
wherein, in particular, the transfer space tapers in the direction of gravity at least in sections or comprises an upper part of the collection hopper relative to the direction of gravity.

5. The apparatus in accordance with claim 4, wherein the transfer space is subdivided by a dividing element into at least one first transfer space region and at least one second transfer space region.

6. The apparatus in accordance with claim 5, wherein the dividing element at least one of
a) defines a first dividing element side face, which points in the direction toward the compressing device outlet and laterally delimits the first transfer space region,
wherein, in particular, the first dividing element side face extends in parallel or substantially in parallel to the direction of gravity,
and
b) reaches at least up to the collection hopper
and
c) dips at least with its lower part relative to the direction of gravity into the collection hopper,
wherein, in particular, the collection hopper defines a hopper height that extends from the introduction opening, which defines the greatest cross section of the collection hopper, up to a collection hopper outlet, which defines the smallest cross section of the collection hopper, and wherein a relative immersion depth of the dividing element into the collection hopper commencing from the introduction opening relative to the hopper height is in a range of about 10% to about 50%, in particular in a range of about 20% to about 40%.

7. The apparatus in accordance with claim 5, wherein at least one of
a) the first transfer space region is closed counter to the direction of gravity
and
b) at least one of the first transfer space region and the second transfer space region is fluidically connected to the introduction opening
and
c) the second transfer space region expands in cross section counter to the direction of gravity
and
d) an exhaust gas outlet is arranged or formed at the second transfer space region,
wherein, in particular, at least one of
the exhaust gas outlet fluidically connects the second transfer space region to an environment of the apparatus and wherein the exhaust gas outlet defines a longitudinal axis, which extends in parallel or substantially in parallel to the direction of gravity
and
a retaining element that is permeable to gas and impermeable to CO₂ pellets is arranged or formed at or before the exhaust gas outlet
and
the retaining element is configured in the form of a grate, a net, or a perforated metal sheet.

8. The apparatus in accordance with claim 1, wherein the apparatus comprises a separating device for separating excess CO₂ gas and CO₂ pellets and wherein the separating device comprises the transfer device, in particular the transfer space,
wherein, in particular, the separating device at least one of
a) comprises at least one flow redirection element for redirecting a flow of excess CO₂ gas from the transfer device inlet to the collection hopper and from the collection hopper to the exhaust gas outlet
and
b) comprises a decelerating device for decelerating the excess CO₂ stream from the collection hopper in the direction toward the exhaust gas outlet,
wherein, in particular, the decelerating device comprises the second transfer space region.

9. The apparatus in accordance with claim 3, wherein at least one of
a) the apparatus comprises a pellet detaching device for detaching CO₂ pellets adhering to the collection hopper,
wherein, in particular, the pellet detaching device comprises a gas accelerating device for accelerating the excess CO₂ gas in the direction toward the collection hopper,
wherein, further in particular, the gas accelerating device comprises the first transfer space region,
and
b) the collection hopper defines an arcuate hopper outlet opening,
wherein, in particular, the hopper outlet opening extends transversely, in particular perpendicularly, to the direction of gravity.

10. The apparatus in accordance with claim 1, wherein the delivery device comprises a dosing device for dosing a number or a defined volume of CO₂ pellets before introduction into a pressurized gas stream for forming a mixed stream of the pressurized gas and CO₂ pellets.

11. A cleaning appliance for blasting surfaces to be treated with a mixed stream of a pressurized gas and CO₂ pellets, wherein the cleaning appliance comprises an apparatus for producing, in particular high-strength, CO₂ pellets from CO₂ snow, wherein the apparatus comprises a compressing device for compressing CO₂ snow to form CO₂ pellets and a delivery device for delivering the CO₂ pellets into a pressurized gas stream, wherein the apparatus comprises a fluid mechanical transfer device for conveying CO₂ pellets from the compressing device to the delivery device and wherein the transfer device is arranged or formed between the compressing device and the delivery device.

12. The cleaning appliance in accordance with claim 11, wherein the cleaning appliance comprises a CO₂ connection for connecting to a CO₂ store containing liquid CO₂ or comprises a CO₂ store containing liquid CO₂.

13. The cleaning appliance in accordance with claim 11, wherein the cleaning appliance comprises a pressurized gas connection for connecting to a pressurized gas generating device or comprises a pressurized gas generating device for generating a pressurized gas stream of a pressurized gas.

14. The cleaning appliance in accordance with claim 11, wherein the cleaning appliance comprises a CO₂ pellet accelerating device for accelerating CO₂ pellets.

15. The cleaning appliance in accordance with claim 14, wherein the CO₂ pellet accelerating device comprises a pressurized gas conduit that is in fluidic connection with the pressurized gas connection or the pressurized gas generating device.

16. The cleaning appliance in accordance with claim 14, wherein at least one of the delivery device and the CO₂ pellet accelerating device comprises at least one venturi nozzle.

17. The cleaning appliance in accordance with claim 13, wherein a blasting connection is arranged or formed downstream from the delivery device for connecting to a blasting conduit or wherein the delivery device downstream is in fluidic connection with a blasting conduit,
wherein, in particular, a blasting nozzle is arranged or formed on a free end of the blasting conduit.

18. The cleaning appliance in accordance with claim 11, wherein the cleaning appliance comprises a CO₂ pellet intermediate store for intermediately storing the produced CO₂ pellets,
wherein, in particular, the transfer device comprises the CO₂ pellet intermediate store.

19. A method for producing, in particular high-strength, CO₂ pellets from CO₂ snow, in particular for a cleaning appliance for blasting surfaces to be treated with a mixed stream of a pressurized gas and CO₂ pellets, in which method CO₂ snow is compressed to form CO₂ pellets, wherein the formed CO₂ pellets are fluid mechanically transferred for delivery or introduction into a pressurized gas stream.

20. The method in accordance with claim 19, wherein the CO₂ pellets are fluid mechanically transferred with excess CO₂ gas
wherein, in particular, the excess CO₂ gas at least one of
a) is hereby accelerated
and
b) is separated, in particular fluid mechanically, from the CO₂ pellets before the delivery or introduction of the CO₂ pellets into the pressurized gas stream.
